(19) United States
(12) Patent Application Publication
(10) Pub. No.: US 2015/0098323 A1
(43) Pub. Date: Apr. 9, 2015

(54) METHOD AND APPARATUS FOR TRANSMITTING TRAFFIC IN MOBILE NETWORK

(71) Applicant: Samsung Electronics Co., Ltd., Gyeonggi-do (KR)

(72) Inventors: Han Na Lim, Seoul (KR); Ji Cheol Lee, Gyeonggi-do (KR); Hyung Ho Lee, Seoul (KR)

(21) Appl. No.: 14/510,063

(22) Filed: Oct. 8, 2014

(30) Foreign Application Priority Data
Oct. 8, 2013 (KR) 10-2013-0119719

(51) Int. Cl. H04W 28/02; H04L 12/859

(52) U.S. Cl. CPC H04W 28/0263; H04W 28/0268; H04W 28/0236; H04L 47/2475
USPC 370/230

(57) ABSTRACT

A method and apparatus for transmitting traffic in a mobile network is provided. The traffic transmission method includes receiving data traffic including chunk information. The traffic transmission method also includes modifying bearer characteristics based on the chunk information of the received data traffic. The traffic transmission method further includes transmitting the data traffic to user equipment (UE) based on the modified bearer characteristics. A method for transmitting data traffic of a Deep Packet Inspection (DPI) node includes receiving data traffic from a data server. The method for transmitting data traffic of the DPI node also includes extracting chunk information regarding the received data traffic. The method for transmitting data traffic of the DPI node further includes transmitting the received data traffic and the extracted chunk information to an eNB.

### CROSS-REFERENCE TO RELATED APPLICATION(S) AND CLAIM OF PRIORITY

The present application is related to and claims priority from and the benefit under 35 U.S.C. §119(a) of Korean Patent Application No. 10-2013-0119719, filed on Oct. 8, 2013, which is hereby incorporated by reference for all purposes as if fully set forth herein.

### TECHNICAL FIELD

The present disclosure relates to a method and apparatus for transmitting traffic between entities in a mobile network. More particularly, the present disclosure is related to a method and apparatus for modifying bearer characteristics according to traffic characteristics.

### BACKGROUND

With rapid development of mobile network technology, the number of users using the Internet via mobile devices has increased, and their accessible contents have diversified. Under this environment, research is actively being performed to raise a level of user's Internet usage satisfaction. For example, as part of the research, a discussion is made to improve traffic transmission efficiency.

Examining the percentage of conventional Internet traffic, video traffic exceeds 50% of the total Internet traffic. Conventional video traffic is the streaming type and shows one transmission pattern where the video file is transmitted once or another transmission pattern where the video file is split into a number of segments at a preset size and then they are transmitted at a preset interval. Most of the conventional video traffic is transmitted over the Internet by the latter transmission pattern.

### SUMMARY

To address the above-discussed deficiencies, it is a primary object to provide a method and apparatus for transmitting traffic in a mobile network with high transmission efficiency.

The disclosure further provides a method and apparatus for establishing bearer QoS elements used for performing a packet forwarding process according to traffic characteristics, in a base station, without performing bearer modification.

In a first embodiment, a method for transmitting traffic in a base station is provided. The method includes receiving data traffic including chunk information. The method also includes modifying bearer characteristics based on the chunk information of the received data traffic. The method further includes transmitting the data traffic to user equipment (UE) based on the modified bearer characteristics.

In a second embodiment, a base station is provided. The base station includes a communication unit configured to perform data communication. The base station also includes a controller. The controller is configured to receive data traffic including chunk information. The controller is also configured to modify bearer characteristics based on the chunk information of the received data traffic. The controller is further configured to transmit the data traffic to user equipment (UE) based on the modified bearer characteristics.

In a third embodiment, a method for transmitting data traffic of Deep Packet Inspection (DPI) node is provided. The method includes receiving data traffic from a data server. The method also includes extracting chunk information regarding the received data traffic. The method further includes transmitting the received data traffic and the extracted chunk information to a base station.

In a fourth embodiment, a Deep Packet Inspection (DPI) node is provided. The DPI node includes a communication unit configured to perform data communication. The DPI node also includes a controller. The controller is configured to receive data traffic from a data server. The controller is also configured to extract chunk information regarding the received data traffic. The controller is further configured to transmit the received data traffic and the extracted chunk information to a base station.

In a fifth embodiment, a method for requesting handover in Mobility Management Entity (MME) is provided. The method includes receiving a handover request including information regarding Radio Access Network (RAN) adjustable Quality of Service (QoS) from a source base station. The method also includes determining whether a target base station supports RAN adjustable QoS (RAQ) set according to the handover request. The method further includes transmitting, when the target base station supports RAQ, a handover request, including information that the source base station set to transmit chunks, to the target base station.

In a sixth embodiment, a Mobility Management Entity (MME) is provided. The MME includes a communication unit configured to perform data communication. The MME also includes a controller. The controller is configured to receive a handover request including information regarding Radio Access Network (RAN) adjustable Quality of Service (QoS) from a source base station. The controller is configured to determine whether a target base station supports RAN adjustable QoS (RAQ) set according to the handover request. The controller is configured to transmit, when the target base station supports RAQ, a handover request, including information that the source base station set to transmit chunks, to the target base station.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:disclosure

FIG. 1 illustrates a view that describes an example method for transmitting video traffic according to this disclosure;

FIG. 2 illustrates a flow chart that describes an example method for modifying characteristics of bearer Quality of Service (QoS) in an LTE network according to this disclosure;

FIG. 3 illustrates a view that describes an example LTE network according to this disclosure;

FIG. 4 illustrates a table that describes an example bearer context stored in MME after user equipment (UE) first accesses an LTE network according to this disclosure;

FIG. 5 illustrates a flow chart that describes an example method for establishing Radio Access Network (RAN) adjustable QoS in a network according to this disclosure;

FIG. 6 illustrates a flow chart that describes an example case where a target base station doesn't support an RAN adjustable QoS function according to this disclosure;

FIG. 7 illustrates a flow chart that describes an example case where a target base station supports an RAN adjustable QoS function according to this disclosure;

FIG. 8 illustrates a schematic block diagram that describes an example base station according to this disclosure;

FIG. 9 illustrates a schematic block diagram that describes an example Deep Packet

Inspection (DPI) node according to this disclosure; and

FIG. 10 illustrates a schematic block diagram that describes an example Mobility Management Entity (MME) according to this disclosure.

### DETAILED DESCRIPTION

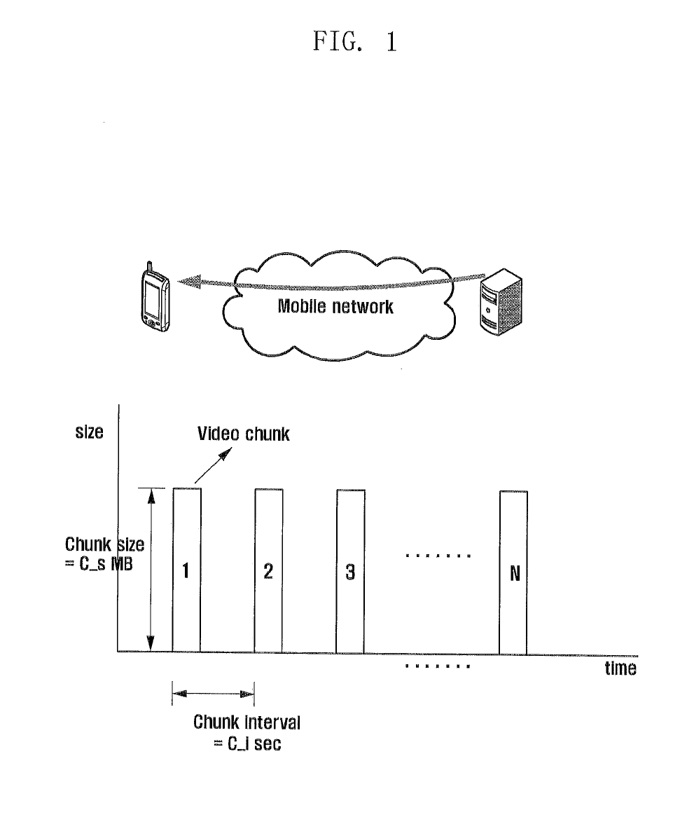

FIGS. 1 through 10, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged communication system. Hereinafter, embodiments of the present disclosure are described in detail with reference to the accompanying drawings. In the drawings, the same or similar elements are denoted by the same reference numerals even though they are depicted in different drawings. In the following description, a detailed description of known functions, configurations, and operations incorporated herein will be omitted when it may make the subject matter of the disclosure less clear.

FIG. 1 illustrates a view that describes an example method for transmitting video traffic according to this disclosure.

Referring to FIG. 1, one video file is split into N video segments, or N video chunks. Each of the video chunks is C_s MB and they are transmitted to user equipment (UE) at an interval C_i second. When video traffic is transmitted over a mobile network, the mobile network estimates times of a preset size of traffic transmitting to UE and the interval between the transmissions.

Transmission of a video file is explained over an LTE network, for example. An LTE network makes transmission for all the Internet video traffic except for video traffic for service provider video call, via a default bearer providing best effort services. That is, an LTE network makes transmission of the traffic of a default bearer, regardless the characteristics of the Internet video traffic. For example, base station (or eNB) makes a schedule for data of a default bearer, indifferently. In accordance with exemplary embodiment of the present disclosure a base station can be used as an eNB (evolved node B).

However, different types of characteristics of bearer QoS may be requested according to video traffic patterns. For example, for a video traffic of a preset size transmitting at a preset chunk interval, there a delay budget, one of the settings of a default bearer QoS, is set shorter than 300 ms to make the transmission more efficient. In another example, the delay budget is set to be relatively longer to make the transmission more efficient. The characteristics of a bearer QoS, set according to video traffic patterns, is used to efficiently transmit video traffic to a UE on mobile network. For example, when an eNB makes a schedule according to delay budget, the eNB sets the video traffic, where the delay budget is set to be relatively long, to lower the transmission priority, and the video traffic, where the delay budget is set to be relatively short, to raise the transmission priority, so that the mobile network can respond to QoS requests of a number of users, with limited resources. That is, users' QoS is enhanced by setting or modifying the characteristics of a bearer QoS, according to the characteristics of video traffic.

In the LTE network, the bearer QoS is expressed by parameters, QoS Class Identifier (QCI), Generated Bit Rate (GBR), Maximum Bit Rate (MBR), Allocation and Retention Priority (ARP), and the like. Since GBR and MBR are parameters set to the GBR bearer, they are not related to the characteristics of the default bearer. ARP indicates the priority of allocation and retention of bearers in the LTE network. ARP is used to determine, when resources are insufficient, whether to accept a request of establishing or modifying bearers. ARP is also used to set a bearer to drop when performing a handover process. The ARP value is not used for data transmission by eNB for example, scheduling and rate controlling and not transmitted to users. QCI is used for packet forwarding in a bearer. For example, QCI includes scheduling weights, admission thresholds, queue management thresholds, and link layer protocol configuration. QCI also includes Resource Type, Packet Delay Budget, Packet Error Loss Rate, etc.

As described above, the embodiment of the present disclosure can modify QoS characteristics according to traffic characteristics, and provide enhanced QoE. The embodiments can also modify QCI to modify QoS characteristics. As an example of modifying QCI, the embodiments can modify Packet Delay Budget.

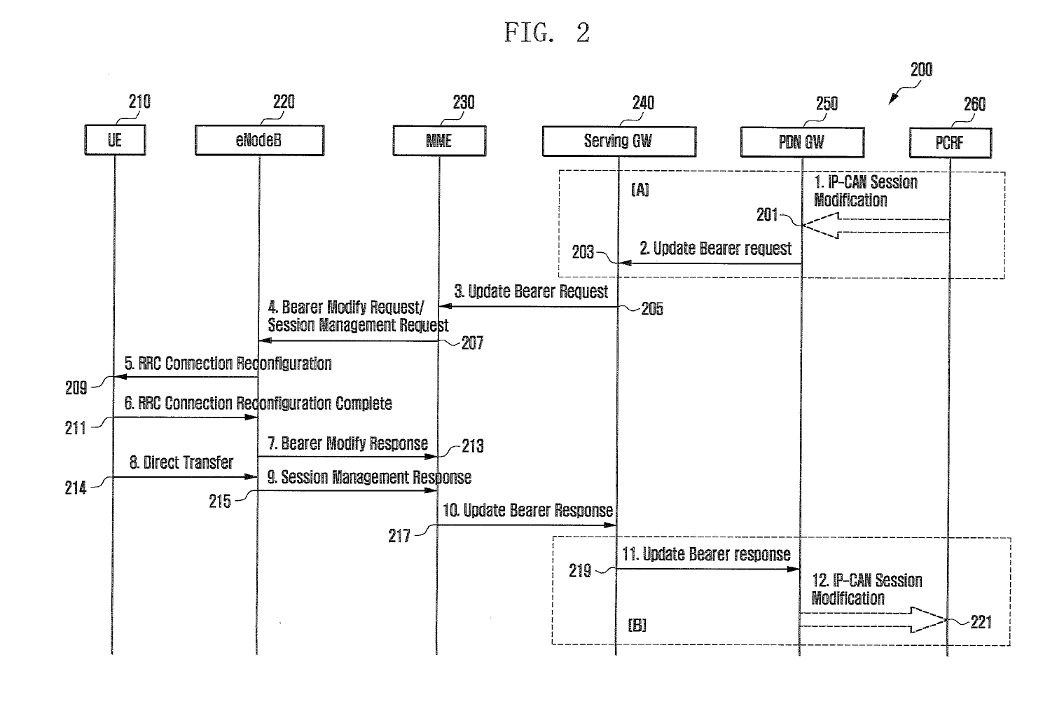

FIG. 2 illustrates a flow chart that describes an example method for modifying characteristics of bearer QoS in an LTE network according to this disclosure.

Referring to FIG. 2, mobile network 200 performs the modification of bearer QoS of UE 210 according to the request by UE 210 or when networking is needed.

Policy and Charging Rule Function (PCRF) 260 transmits QoS policy to PGW 250 (at step 201). PGW 250 updates bearer QoS using the received QoS policy, and transmits it to Serving Gate Way (SGW) 240 (at step 203). SGW 240 transmits the modified bearer QoS to MME 230 (at step 205). MME 230 transmits the modified bearer QoS to eNB 220 (at step 207). ENB 220 maps the modified EPS bearer QoS to radio bearer QoS. eNB 220 transmits the modified radio bearer QoS to UE 210 (at step 209). UE 210 transmits a response message for the received, modified radio bearer QoS to eNB 220 (at step 211). As shown in FIG. 2, when the entities 210, 220, 230, 240, 250, and 260 receive the messages at steps 201, 203, 205, 207, and 209, they acknowledge them with responses respectively (steps 213, 214, 215, 217, 219, and 221).

Referring to the flow chart shown in FIG. 2, to adjust bearer QoS according to video traffic, the method performs the bearer modification each time that video transmission to UE 210 happens. This causes signaling messages at least 11 times, and also causes UE 210 to perform signaling, thereby wasting radio resources.

To resolve the problems described above, the following method and apparatus according to the embodiments of the present disclosure sets bearer QoS elements used for packet forwarding process, according to traffic characteristics, without performing the steps for bearer modification.

A radio network modifies bearer QoS to correspond to traffic characteristics used for packet forwarding process. Radio network can set/modify one of the characteristics of bearer QoS, which is not transmitted to UE but is used for packet forwarding processing, to correspond to traffic characteristics. The element is called RAN adjustable QoS in the following description. In the following embodiments, radio network performs packet forwarding process by using RAN adjustable QoS. When handover occurs, a core network determines whether a target radio network supports RAN adjustable QoS. When a core network ascertains that a target radio network supports RAN adjustable QoS, it transmits the set value to the target radio network.

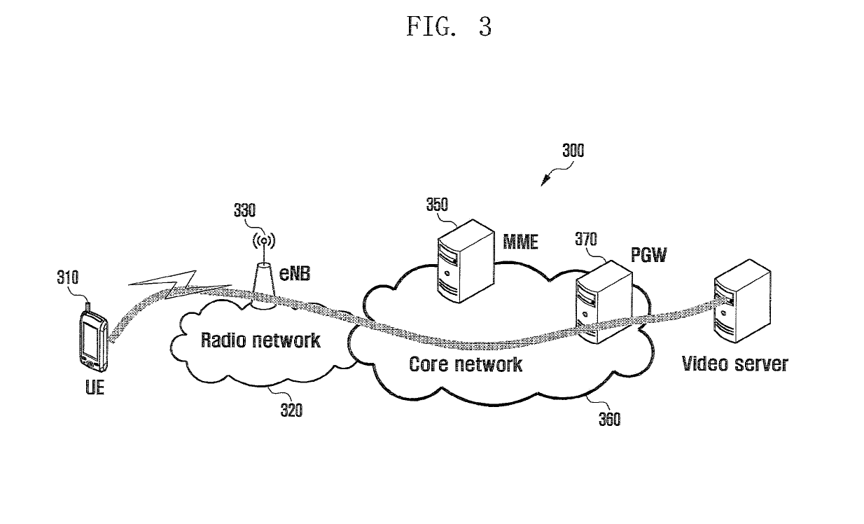

FIG. 3 illustrates a view that describes an example LTE network according to this disclosure.

Referring to FIG. 3, LTE network 300 includes radio network 320 and core network 360. Radio network 320 includes eNB 330. Core network 360 includes MME 350 and PGW 370. MME 350 is an entity that manages mobility between UE 310 and mobile network. PGW 370 manages traffic transmitted to UE 310.

The following embodiments of the present disclosure are described based on LTE network. When data traffic corresponding to a request of UE 310 (such as video traffic) has arrived, upper node of the network extracts the characteristics of the data traffic. The upper node includes Deep Packet Inspection (DPI) node. DPI node can extract the characteristics of data traffic by using DPI function and the like. DPI node includes PGW 370 or TDF. In the following description, DPI node is described as PGW. PGW 370 extracts the characteristics of video traffic by using DPI function and the like. The extracted characteristics of video traffic can be video chunk size, video chunk interval, and the like, for example. In the following description, although the embodiments are described based on video traffic, it should be understood that the disclosure is not limited to the video traffic. PGW 370 transmits information regarding the extracted characteristics of data traffic to radio network. PGW 370 can include information regarding the extracted characteristics of data traffic in the GTP-U extension header for transmitting data packet, in the LTE network. PGW 370 transmits the information regarding the extracted characteristics of data traffic to eNB 330. The information regarding the characteristics of data traffic can be transmitted by using GTP-U. PGW 370 or TDF can extract information regarding video data by using DPI function, and Part of GTP-U can use a method well-known in 3GPP (SIRIG: GTP-U extension header). ENB 330 extracts characteristics of video traffic from the GTP-U extension header. ENB 330 modifies the extracted information regarding characteristics of video traffic to RAN adjustable QoS according to this disclosure.

The RAN adjustable QoS according to this disclosure includes QoS characteristics that are not transmitted to UE but used for packet forwarding process, and the like in eNB 330. ENB 330 adjusts RAN adjustable QoS and provides better QoE to users. An example of RAN adjustable QoS is delay budget. ENB 330 adjusts delay budget to correspond to traffic characteristics. The adjusted delay budget is applied to scheduling weights of eNB 330, and the like and also prioritizes transmission of video traffic to enhance user QoE.

When UE 310 of bearer with RAN adjustable QoS performs handover, MME 350 determines whether target eNB supports RAN adjustable QoS. When MME 350 ascertains that target eNB supports RAN adjustable QoS, it includes RAN adjustable QoS transmitted from the source eNB in handover message and transmits it to target eNB. Target eNB applies the received RAN adjustable QoS to the bearer.

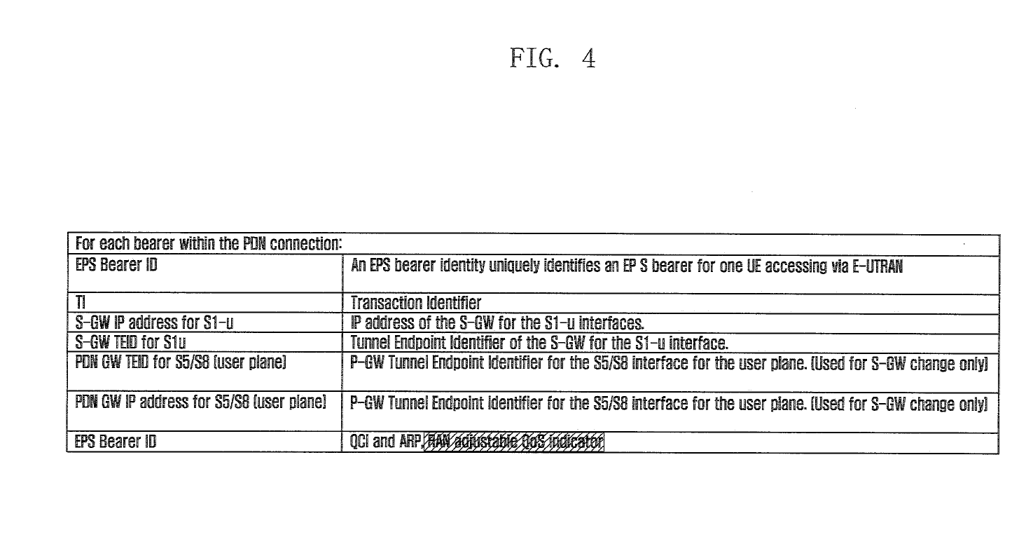

FIG. 4 illustrates an example table that describes a bearer context stored in MME after UE first accesses an LTE network, according to this disclosure.

Referring to FIG. 4, when UE accesses an LTE network, MME fetches subscription information regarding the UE from a server. Subscription information includes information for determining whether UE can receive better QoS by RAN adjustable QoS. When MME ascertains that UE can receive better QoS by RAN adjustable QoS from the fetched subscription information, the MME indicates the UE as a bearer with RAN adjustable QoS function in the UE bearer information.

As shown in FIG. 4, MME includes RAN adjustable QoS indicator according to the disclosure in the EPS bearer QoS field. The bearer can be a default bearer of the Internet APN. When UE is attached to a network, RAN adjustable QoS is set to a default QoS value allocated to the bearer. As described above, the embodiments of the present disclosure can provide service subscribers with premium services after checking their subscription information, or it can provide all network users with general services.

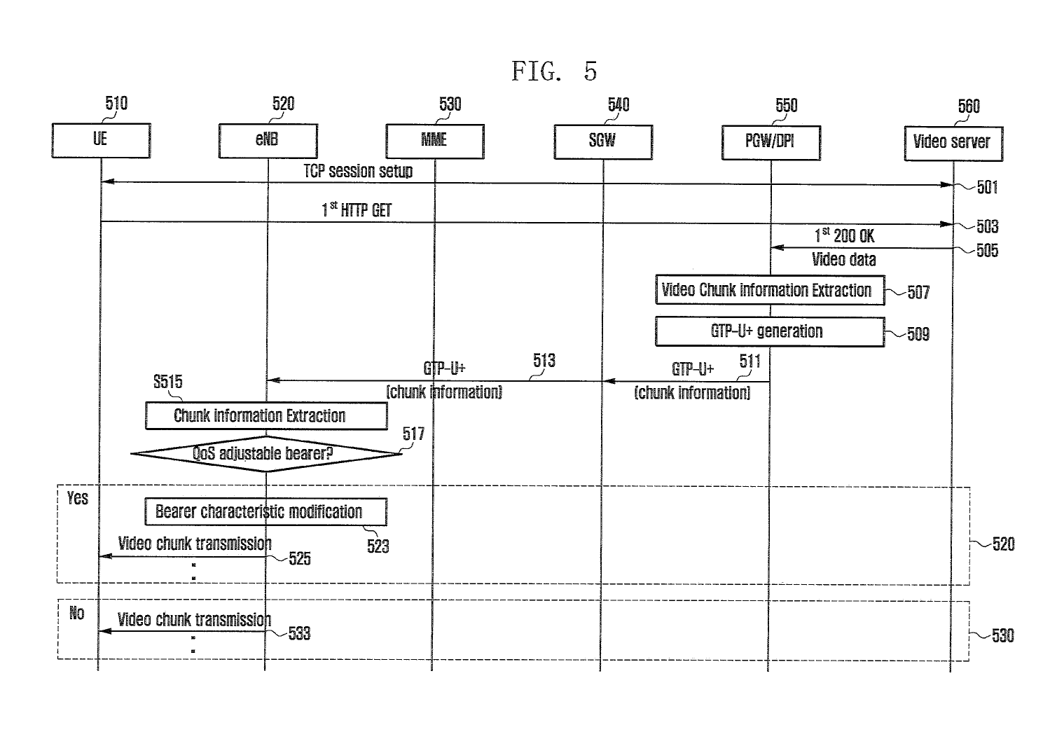

FIG. 5 illustrates a flow chart that describes an example method for establishing Radio Access Network (RAN) adjustable QoS in a network according to this disclosure.

Referring to FIG. 5, UE 510 sets up TCP session with video server 560 (at step 501). UE requests video files from video server 560 by HTTP Request (at step 503). Video server 560 transmits video traffic corresponding to HTTP Request to PGW 550 (at step 505). PGW 550 extracts video traffic characteristics by using DPI function, and the like (at step 507). PGW creates GTP-U extension header including video traffic characteristics by using the extracted video traffic characteristics (at step 509). PGW 550 transmits video traffic to SGW 540. PGW 550 transmits video traffic with the extension header in the format of GTP-U to SGW 540 (at step 511).

SWG 540 transmits the received video traffic to eNB 520 (at step 513). ENB 520 extracts chunk information from the received video traffic (at step 515). ENB 520 determines whether the bearer is a QoS adjustable bearer (at step 517). When eNB 520 ascertains that the bearer is a QoS adjustable bearer at step 517, it performs step 520. At step 520, eNB 520 modifies the bearer characteristics to correspond to video chunk information (at step 523) and transmits video chunk to UE 510 (at step 525). On the contrary, when eNB 520 ascertains that the bearer isn't a QoS adjustable bearer at step 517, it performs step 530. At step 530, eNB 520 transmits video chunk to UE 510 (at step 533).

After completing the transmission of video files, eNB 520 retains the set RAN adjustable QoS or sets it to a bearer default value. In order to determine whether transmission of video files is completed, the following processes are performed. First, PGW/DPI detects the transmission end of video files. PGW/DPI includes the transmission end information in GTP-U extension header and then transmits it to eNB. The eNB detects the transmission of video files by the received information. Second, when eNB doesn't detect a chunk file over the video chunk interval from the arrival of the last video chunk file, it ascertains that transmission of video files is completed. Third, when eNB doesn't detect an arrival of any chunk files over a preset period of time and the chunk interval, it ascertains that transmission of video files is completed.

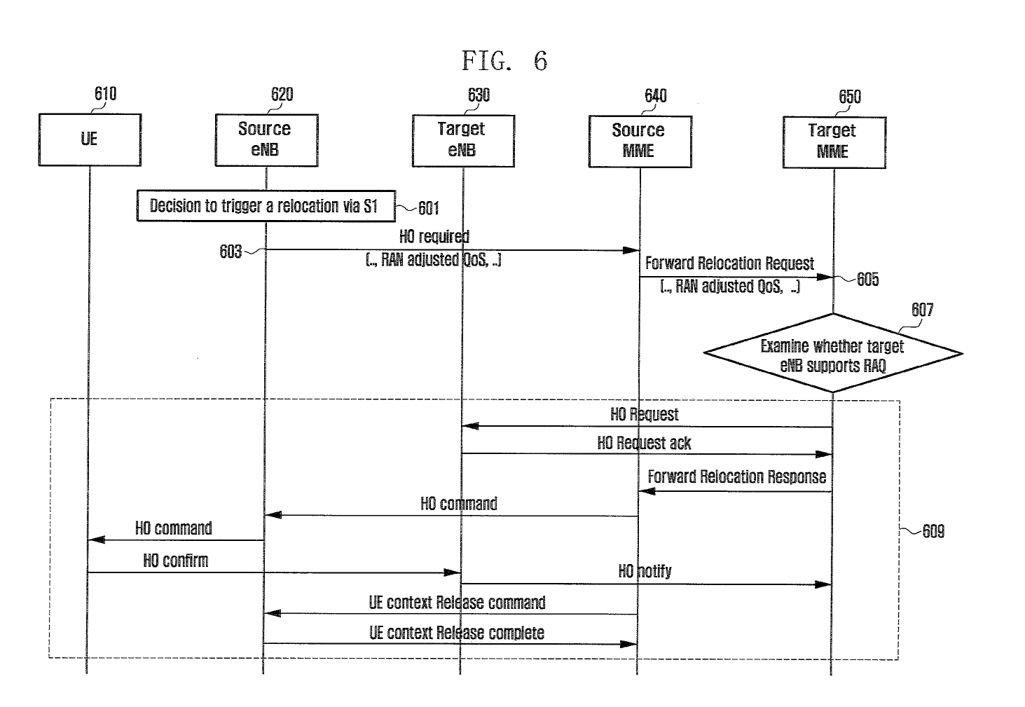

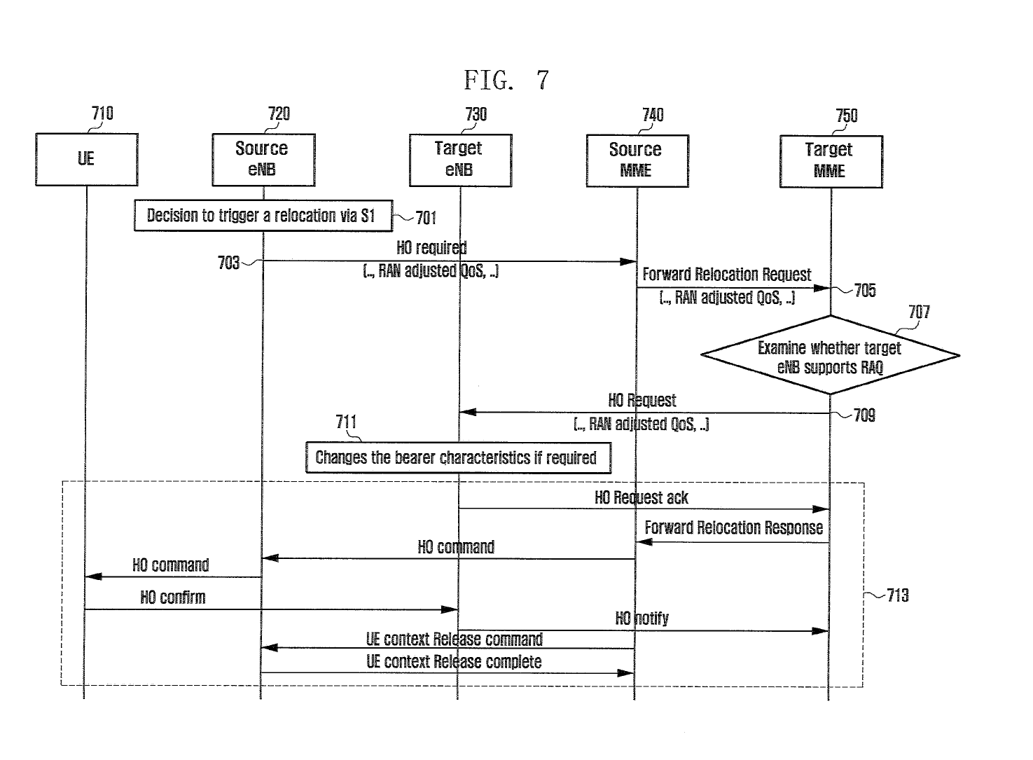

The operation of UE of a bearer with RAN adjustable QoS during handover is described in detail, referring to FIGS. 6 and 7. FIG. 6 illustrates a flow chart that describes an example case where a target eNB doesn't support an RAN adjustable QoS function, according to this disclosure. FIG. 7 illustrates a flow chart that describes an example case where a target eNB supports an RAN adjustable QoS function, according to this disclosure.

Referring to FIG. 6, source eNB 620 detects that UE 610 needs handover (S601). Source eNB 620 transmits a handover request message, HO Required, to source MME 640. The HO Required message includes information ( . . . , RAN adjustable QoS, . . . ) indicating that source eNB 620 is providing RAN adjustable QoS to UE needing handover. RAN adjustable QoS is a parameter that source eNB 620 set to transmit video chunks. RAN adjustable QoS can be included in a source-to-target transparent container parameter transmitted via HO Required message or can be transmitted as an independent parameter (at step 603). Source MME 640 transmits RAN adjustable QoS, transmitted from source eNB 620, to target MME 650. Source MME 640 transmits RAN adjustable QoS related information via a message of Forward Relocation Request ( . . . , RAN adjustable QoS, . . . ). RAN adjustable QoS can be included in a source-to-target transparent container parameter transmitted via Forward Relocation message, or can be transmitted as an independent parameter (at step 605). Target MME 650 determines whether target eNB 630 supports RAN adjustable QoS function (at step 607). The embodiment shown in FIG. 6 is implemented assuming that target eNB 630 doesn't support RAN adjustable QoS function. Target MME 650 performs processes related to handover without using RAN adjustable QoS function (at step 609).

Referring to FIG. 7, when target eNB supports RAN adjustable QoS function, the operation of the embodiment is described as follows.

Since steps 701, 703, and 705 correspond to steps 601, 603, and 605 shown in FIG. 6, which have been described above, they are not explained in the following description. After step 705 or 605, target MME 750 determines whether target eNB 730 supports RAN adjustable QoS function (at step 707). The embodiment shown in FIG. 7 is implemented assuming that target eNB 730 supports RAN adjustable QoS function.

Target MME 750 transmits a request message of handover, HO Request, to eNB 730 (S709). HO Request message includes RAN adjustable QoS related information. The RAN adjustable QoS related information is information that target MME 750 receives via steps at steps 701, 703, and 705. Target eNB 730 identifies the RAN adjustable QoS and can modify bearer QoS characteristics, if necessary, (at step 711). Target eNB 730 performs processes related to handover (at steps 713).

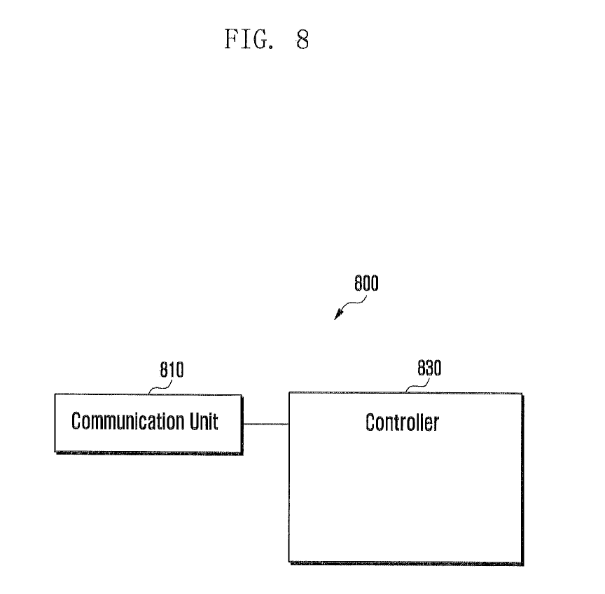

FIG. 8 illustrates a schematic block diagram that describes an example eNB according to this disclosure.

Referring to FIG. 8, eNB 800 includes a communication unit 810 for performing data communication and a controller 830 for controlling the entire operation.

The controller 830 controls bearer QoS elements according to traffic characteristics. The controller 830 receives data traffic including chunk information, modifies bearer characteristics based on the chunk information of the received data traffic, and transmits the data traffic to user equipment (UE) based on the modified bearer characteristics.

The controller 830 determines whether the UE supports Radio Access Network adjustable QoS, and modifies the bearer characteristics when the UE supports Radio Access Network adjustable QoS.

The controller 830 modifies QoS Class Identifier (QCI) characteristics used for processing bearer packet forwarding to modify the bearer characteristics. The controller 830 modifies delay budget of the QCI characteristics.

The controller 830 extracts the chunks from GTP-U extension header for the data traffic.

It should be understood that the controller 830 can perform the operations of eNBs shown in FIG. 2 to FIG. 7.

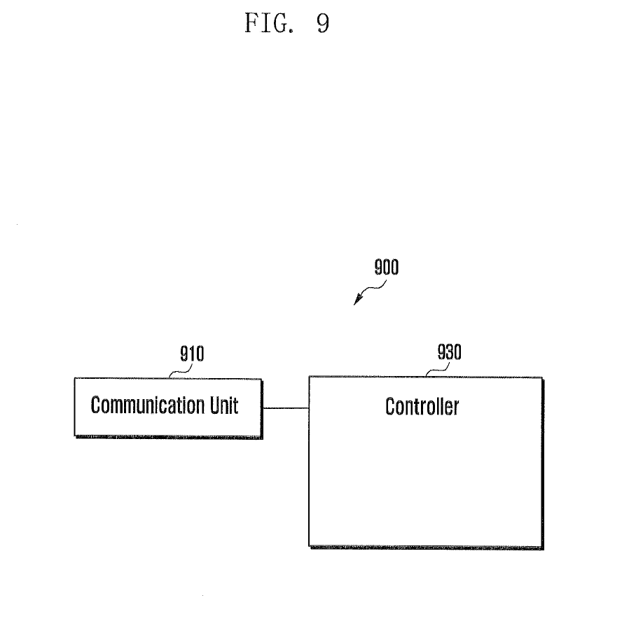

FIG. 9 illustrates a schematic block diagram that describes an example Deep Packet Inspection (DPI) node according to this disclosure.

Referring to FIG. 9, DPI node 900 includes a communication unit 910 for performing data communication and a controller 930 for controlling the entire operation.

The DPI node is included in an upper node. The DPI node can be PGW or TDI.

According to an embodiment of the present disclosure, the controller 930 receives data traffic from a data server. The controller 930 extracts chunks from the received data traffic. The controller 930 transmits the received data traffic and the extracted chunks to eNB.

The controller 930 transmits the data traffic via GTP-U, and controls GTP-U extension header to transmit the extracted chunks.

It should be understood that the controller 930 can perform the operations of DPI nodes shown in FIG. 2 to FIG. 7.

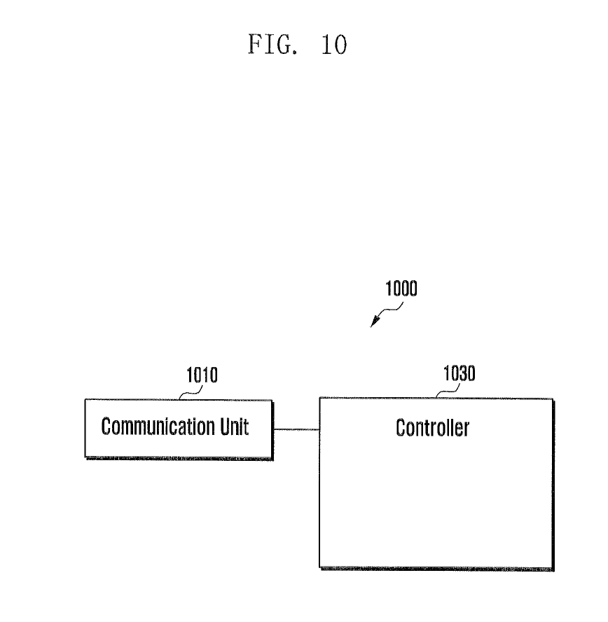

FIG. 10 illustrates a schematic block diagram that describes an example Mobility Management Entity (MME) according to this disclosure.

Referring to FIG. 10, MME 1000 includes a communication unit 1010 for performing data communication and a controller 1030 for controlling the entire operation.

The controller 1030 receives handover request including RAN adjustable QoS from source eNB. The controller 1030 determines whether target eNB set according to the handover request supports RAN adjustable QoS (RAQ). When the controller 1030 ascertains that target eNB supports RAQ, it transmits a handover request, including information that the source eNB set to transmit chunks, to the target eNB.

It should be understood that the controller 930 can perform the operations of MMEs shown in FIG. 2 to FIG. 7.

Although the embodiments of the present disclosure have been explained based on video traffic, it should be understood that the disclosure is not limited to the embodiments. The present disclosure can also be applied to other types of traffic with RAN adjustable QoS technology.

According to the embodiments of the present disclosure as described above, the characteristics of bearer QoS can be modified in a mobile network and between user equipment and the mobile network, without creating additional signaling.

According to the embodiments of the present disclosure as described above, only part of the bearer QoS can be modified. In addition, a mobile network can provide user equipment with enhanced Quality of Experience (QoE), via limited resources, using the modified bearer QoS.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for transmitting traffic by a base station, the method comprising:
receiving data traffic including chunk information;
modifying bearer characteristics based on the chunk information of the received data traffic; and
transmitting the data traffic to a user equipment (UE) based on the modified bearer characteristics.

2. The method of claim 1, further comprising:
determining whether the UE supports radio access network adjustable quality of service(QoS); and
modifying the bearer characteristics when the UE supports Radio Access Network adjustable QoS.

3. The method of claim 1, wherein modifying the bearer characteristics comprises:
modifying QoS class identifier (QCI) characteristics used for processing bearer packet forwarding.

4. The method of claim 3, wherein modifying QCI characteristics comprises:
modifying delay budget by the base station in itself

5. The method of claim 1, further comprising:
extracting the chunk information from GTP-U extension header for the data traffic.

6. The method of claim 1, wherein the chunk information comprises:
information regarding transmission intervals of a number of chunks to which the data traffic is split.

7. The method of claim 1, wherein the data traffic comprises:
video traffic.

8. A base station comprising:
a communication unit configured to perform data communication with at least one network node; and
a controller configured to:
receive data traffic including chunk information,
modify bearer characteristics based on the chunk information of the received data traffic, and
transmit the data traffic to a user equipment (UE) based on the modified bearer characteristics.

9. The base station of claim 8, wherein the controller is configured to:
determine whether the UE supports Radio Access Network adjustable quality of service (QoS); and modify the bearer characteristics when the UE supports radio access network adjustable QoS.

10. The base station of claim 8, wherein the controller is configured to modify QoS class identified (QCI) characteristics used for processing bearer packet forwarding to modify the bearer characteristics.

11. The base station of claim 10, wherein the controller is configured to allow the base station in itself to modify delay budget of the QCI characteristics.

12. The base station of claim 8, wherein the controller is configured to extract the chunk information from GTP-U extension header for the data traffic.

13. The base station of claim 8, wherein the chunk information comprises: information regarding transmission intervals of a number of chunks to which the data traffic is split.

14. A method for transmitting data traffic of deep packet inspection (DPI) node comprising:
receiving data traffic from a data server;
extracting chunk information regarding the received data traffic; and
transmitting the received data traffic and the extracted chunk information to a base station.

15. The method of claim 14, wherein transmitting the received data traffic and the extracted chunk information to a base station comprises:
transmitting the data traffic via GTP-U; and
transmitting the extracted chunk information via an extension header of the GTP-U.

16. The method of claim 14, wherein the DPI node comprises:
P-Gate Way (PGW).

17. The method of claim 15, wherein the chunk information is used to modify delay budget of QoS class identifier (QCI) characteristics in the base station.

18. A deep packet inspection (DPI) node comprising:
a communication unit configured to perform data communication with other network node; and
a controller configured to:
receive data traffic from a data server,
extract chunk information regarding the received data traffic, and
transmit the received data traffic and the extracted chunk information to a base station.

19. The DPI node of claim 18, wherein the controller is configured to:
transmit the data traffic via GTP-U; and
control an extension header of the GTP-U to transmit the extracted chunk information.

20. The DPI node of claim 18, wherein the chunk information is used to modify delay budget of QCI characteristics in the eNB.
